(19) United States
(12) Patent Application Publication
(10) Pub. No.: US 2011/0046022 A1
(43) Pub. Date: Feb. 24, 2011

(54) CRYSTALLIZATION DEVICE FOR HIGH-THROUGHPUT VISUAL INSPECTION AND X-RAY DIFFRACTION ANALYSIS

(76) Inventors: Nickolay Chirgadze, Toronto (CA); Joseph Miller, Whitby (CA); Robert Lam, Toronto (CA); Kathy Johns, Toronto (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/747,029

(22) PCT Filed: Dec. 11, 2008
(86) PCT No.: PCT/CA08/02153

§ 371 Date: Nov. 4, 2010

Related U.S. Application Data
(60) Provisional application No. 61/013,073, filed on Dec. 12, 2007.

(51) Int. Cl. C40B 60/12

(52) U.S. Cl. 506/39

(57) ABSTRACT

A crystallization chip has a two-dimensional substrate surface with modified wetting properties convenient for the evaluation of the crystallization experiment results by optical microscope and by X-ray diffraction. A crystallization chip mount comprises a base and a support structure that is connected to the base. The support structure provides a first channel that receives a portion of the crystallization chip. A crystallization chip holder comprises a body defining at least one slot to slidably receive the crystallization chip described herein. The at least one slot extends from an upper surface to a lower surface of the body. The crystallization chip holder further includes at least one support surface for each slot. For a given slot the at least one support surface is disposed on an edge of at least two surfaces of portions of the body that define the given slot. During use, the at least one support surface supports the crystallization chip prior to, during or after the formation of crystals.

### FIELD OF THE INVENTION

The application relates to a novel device and improved methods for crystallization analysis, particularly high-throughput visual inspection and X-ray diffraction.

### BACKGROUND OF THE INVENTION

Protein X-ray crystallography is an analytical technique that uses the diffraction pattern produced by irradiating a single protein crystal with an X-ray beam to determine three-dimensional (crystal) structure of the protein molecule in the crystal. The process of the crystal structure determination can be divided into the following stages:
(1) Protein Production (i.e. cloning, expression, and purification);
(2) Screening of the crystallization conditions or crystallization hits identification;
(3) Crystallization hits assessment (i.e. visual inspection, by X-ray diffraction);
(4) Optimization of the crystallization conditions for the most promising crystallization hits to generate collectable quality crystals;
(5) Diffraction data collection and processing; and
(6) Structure determination.

There are numerous disadvantages to current crystal structure determination techniques.

Conventional crystallization experiments commonly utilize a relatively large plastic plate with multiple wells. The size and geometry impedes easy optical evaluation, as the entire plate cannot be evaluated in one view.

Conventional crystallization plates commonly contain a grid of 24, 96 or 384 wells and are made of plastics. These are not directly applicable for a conventional X-ray diffractometer. Thus, the grown crystals have to be transferred for analysis. This is problematic because the crystals have to be of a sufficient size and quantity to determine suitable cryoconditions to be tested by X-ray diffraction. In addition, the crystals can be damaged during the transfer.

Further, due to a limited number of crystallization experiments on conventional crystallization platforms (e.g. 384), the optical evaluation of the respective experiments is also restricted in terms of a limited field of view. As a result, during periodic visual inspection, multiple photographs are taken from the crystallization drops over the course of the screening. Every drop has been positioned in the centre prior to the image being taken or analyzed by the operator. So, every drop may have to be moved (i.e. accelerated and decelerated) 24, 96 or 386 times depending on the system.

The “hanging-drop” crystallization method requires turning a cover slip upside-down while it has crystallization drop(s) on one of its surfaces. During this procedure, in some cases (e.g. large size drops), crystallization drops could change their positions and compromise the experiment by mixing multiple drops from the same cover slip together or even slipping out from the cover slip completely.

In addition, the analysis of membrane proteins usually requires detergents containing buffers. Drops of these buffers tend to disperse on common surfaces, impeding crystallization.

Further, optimization of the crystallization conditions is a tedious and time-consuming process.

### SUMMARY OF THE INVENTION

Exemplary embodiments for devices and materials, which can be used for high-throughput crystallization assays are described herein. A crystallization chip is described herein that has a two-dimensional substrate surface with modified wetting properties convenient for the evaluation of the crystallization experiment results by optical microscope and by X-ray diffraction.

Accordingly, one aspect of the present application is a crystallization chip comprising a substrate that has a planar surface and that has one or more hydrophilic regions on the planar surface, wherein each hydrophilic region is bordered by a hydrophobic region. The crystallization chip can be used for high-throughput visual inspection and X-ray diffraction analysis of crystallization experiments.

Another aspect of the application is a crystallization chip mount that comprises a base and a support structure that is connected to the base. The support structure provides a first channel that receives a portion of the crystallization chip described herein.

In one example application, the crystallization chip mount can be configured to fit within the working space of a conventional diffractometer.

A further aspect of the application is a crystallization chip holder that comprises a body defining at least one slot to slidably receive the crystallization chip described herein. The at least one slot extends from an upper surface to a lower surface of the body. The crystallization chip holder further includes at least one support surface for each slot. For a given slot the at least one support surface is disposed on an edge of at least two surfaces of portions of the body that define the given slot. During use, the at least one support surface supports the crystallization chip prior to, during or after the formation of crystals.

An additional aspect of the application is a kit comprising the crystallization chip, crystallization chip mount and/or crystallization chip holder.

Another aspect of the application is a method for high-throughput microbatch crystallization using the crystallization chip disclosed herein.

A further aspect of the application is a method for high-throughput visual and X-ray diffraction analysis of a crystal of a molecule using the crystallization chip disclosed herein.

Other features and advantages of the present invention will become apparent from the following detailed description. It should be understood, however, that the detailed description and the specific examples while indicating exemplary embodiments of the invention are given by way of illustration only, since various changes and modifications within the spirit and scope of the invention will become apparent to those skilled in the art from this detailed description.

### BRIEF DESCRIPTION OF THE DRAWINGS

For a better understanding of the various embodiments of the invention described herein and to show more clearly how they may be carried into effect, reference will now be made, by way of example only, to the accompanying drawings in which:

FIG. 1 is a partial top view of an example of a crystallization chip;

FIG. 2 is a cross section taken along line 2-2 in FIG. 1;

FIG. 3A is a photograph of an example embodiment of a crystallization chip holder and a crystallization chip mount holding a crystallization chip;

FIG. 3B is a cross section taken along line 3B-3B in FIG. 3A;

FIG. 3C is a cross section taken along line 3C-3C in FIG. 3A;

FIG. 3D is a top view of the crystallization chip holder shown in FIG. 3A;

FIG. 3E is a cross section taken along line 3E-3E in FIG. 3D;

FIG. 4 is a photograph of two alternative example embodiments of crystallization chip holders as well as a crystallization chip mount holding a crystallization chip;

FIG. 5A is a top view of an alternative embodiment of the crystallization chip holder;

FIG. 5B is a cross section taken along line 5B-5B in FIG. 5A;

FIG. 6 is a photograph of a crystallization chip mount holding a crystallization chip and mounted on a goniometric head;

FIG. 7 is a photograph of the crystallization chip mount and the goniometric head of FIG. 5 inserted in an X-ray diffractometer;

FIG. 8 is a photograph of an X-ray diffractometer

FIG. 9 is a series of photographs of crystals formed using the crystallization chip described herein;

FIG. 10A is a top view of an alternative embodiment of the crystallization chip holder;

FIG. 10B is a cross section taken along line 10B-10B in FIG. 5A;

FIG. 11A is a top view of an alternative embodiment of the crystallization chip holder; and

FIG. 11B is a cross section taken along line 11B-11B in FIG. 11A;

### DETAILED DESCRIPTION OF THE INVENTION

It will be appreciated that for simplicity and clarity of illustration, elements shown in the Figures have not necessarily been drawn to scale. In addition, numerous specific details are set forth in order to provide an adequate understanding for practicing the various embodiments described herein. However, it will be understood by those of ordinary skill in the art that the various embodiments described herein may be practiced without these specific details. In other instances, some methods, procedures and components have not been described in detail since they are well known to those skilled in the art.

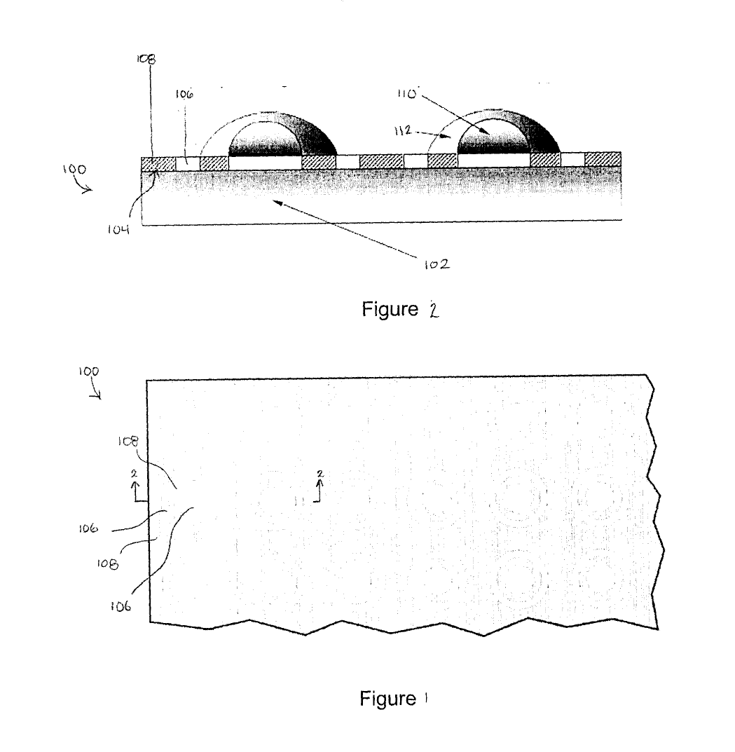

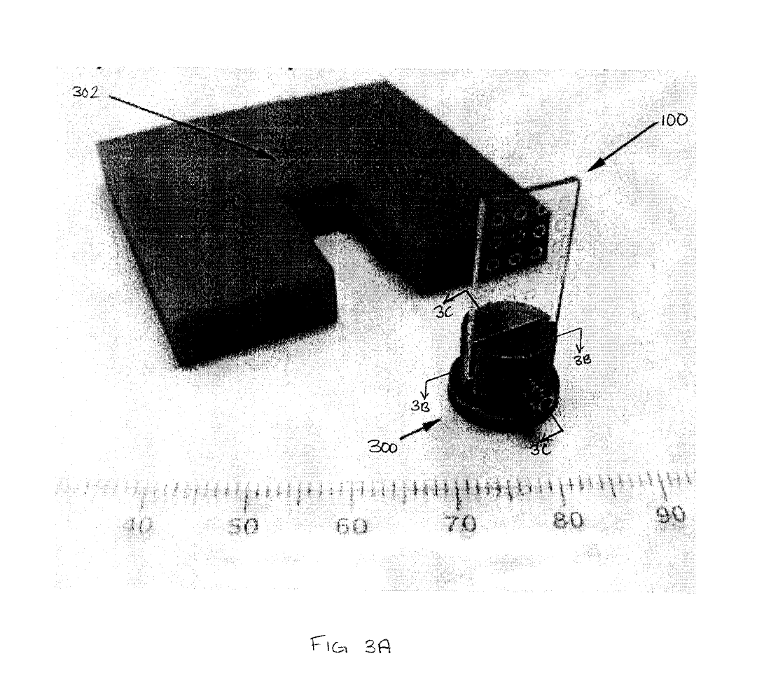

Referring to FIGS. 1 and 2, an example of a crystallization chip 100 with specially modified surface wetting properties is shown. Thus, one aspect of the present application is a crystallization chip comprising a substrate 102 that has a planar surface 104 that has one or more hydrophilic regions 106, wherein each hydrophilic region 106 is bordered by a hydrophobic region 108. As a result of this design, crystallization solutions 110 can be positioned on the hydrophilic 106 regions of the surface 104 of the crystallization chip and because every hydrophilic region 106 is bordered by a more hydrophobic region 108, the solutions 110 can be kept in place.

In an example embodiment, the substrate 102 is a transparent material that will facilitate the convenient observation of crystal formation from the direction perpendicular to the planar surface 104 of the substrate. For example, the transparent material can be glass, quartz, silicone, poly(dimethyl-siloxane) or plastic. In one embodiment, the transparent material is glass.

The crystallization chip 100 disclosed herein allows the crystals to be analyzed without having to transfer the crystals. Since protein crystals are very fragile due to the high solvent content, an in situ analysis results in less agitation of the crystal and less potential to damage the crystal. Furthermore, the use of the crystallization chip 100 disclosed herein saves the labour and time of transferring grown crystals to separate mounting devices (e.g. cryo loops, capillary). It will eliminate the need for identification of the cryoconditions that would require a number of the crystals of the sufficient size. Also, there is no need to add solutions to cryo-freeze the crystals.

Accordingly, in at least one embodiment, the crystallization chip 100 can be insertable into an X-ray diffractometer for analysis of crystallization results in situ. In at least one embodiment, a crystallization chip mount, as described below, is used to facilitate the in situ analysis.

The size of the crystallization chip 100 can vary. In at least one embodiment, the crystallization chip 100 is limited to the size of a microscope viewing area or the size of the diffractometer mounting area. In an example embodiment, the crystallization chip is rectangular and the substrate 102 of has the dimensions of approximately 5 to 10 mm in width and 10 to 20 mm in length. In some examples, the height of the substrate is selected to minimize the absorption of X-rays. For example, the height may be between 0.1 mm and 1 mm, depending on the substrate material.

The hydrophilic regions 106 can be arrayed on the surface of the crystallization chip 100 in any predetermined pattern, such as a grid. Thus, the crystallization chip 100 provides the advantage of being able to obtain diffraction data sets from multiple crystals on the same crystallization chip 100. In an example embodiment, the hydrophilic regions 106 are arrayed in an 8×12 grid. In another example embodiment, the hydrophilic regions 106 are arrayed in a 4×6 grid. In another example embodiment, the hydrophilic regions 106 are arrayed as multiple 8×12 and/or 4×6 grids per crystallization chip.

The hydrophilic regions 106 can vary in size depending on the design of the hydrophilic regions 106 on the surface of the chip. In an example embodiment, the hydrophilic regions 106 have a diameter of about 0.001 to 2 mm depending on the number of crystallization drops.

To influence the crystallization performance, the hydrophilic regions 106 may be of any desired geometry. In an example embodiment, the hydrophilic regions 106 have shapes that are at least one of circular, triangular or hexagonal.

With the crystallization chip 100 described herein, very small sample volumes can be used for crystallization. In this case, only small quantities of samples are used. In addition, the small size of the sample volumes decreases the time it requires for the crystals to form. The volume of solutions that can be used on the crystallization chip is about 1 nl to 50 μl, about 10 nl to 10 μl or about 14 nl to 1 μl. Dependent on the respective sample volumes, about 1 to 5000, about 5 to 4000 or about 9 to 2000 crystallization assays can be positioned on one square centimetre of the crystallization chip.

Rapid evaporation of the protein samples can be avoided by layering the protein solutions individually or altogether with a layer of oil 112. Oil can also be used to introduce very small amounts of liquid onto the crystallization chip surface dramatically reducing the problems of premature evaporation during pipetting.

When using oil 112 to layer individual droplets of protein solution 110, the following surface wetting modification structure can be used. The hydrophilic areas 106 which are arranged for receiving a solution 110 of a molecule, such as a protein, are completely bordered by a hydrophobic region 108 that again are completely bordered by another hydrophilic area 106.

The two-dimensional geometry of the presented crystallization chip 100 grants improved control of the pipetting process, optical control of the crystal formation and detection and concurrent evaluation of a plurality of grown crystals via X-ray diffraction. Furthermore the chance of random crystal formation on edges and rims, as observed when using conventional three-dimensional crystallization devices, is circumvented. Thus, a fully automated high-throughput processing of crystallization samples is feasible.

In an example embodiment, an illuminating crystal mounting step (i.e. putting crystal into a cryo loop or capillary) can be done, which allows analysis of crystals of substantially smaller size, to make a “go” or “no go” decision on a crystallization hit conditions earlier in the process. This step can save days or even weeks on the crystallization hits assessment step of crystal structure determination.

The modified wetting properties of the crystallization chip 100 can be produced by lithographic methods, thus the density of crystallization samples can be decisively increased in contrast to conventional three-dimensional devices. This is important to meet the demand for running many crystallization assays in parallel to test the effect of slight changes in reaction parameters like pH-value, salt and protein concentrations on the crystallization performance.

High density positioning allows the analysis of multiple drops at once and as a result will increase high-throughput, decrease a number of images, and minimize disturbance of the crystallization droplets.

Due to the wetting property modification of the crystallization chip surface, unusual contact angles can be achieved between protein solution and substrate surface. Increasing the sample volume on a hydrophobic 108 area of a certain size will result in an increasing contact angle between liquid and surface leading to a higher ratio between sample volume and sample surface, which is important for diffusion mediated crystallization performance. Therefore, within certain limits, crystallization performance can be influenced by changing the contact angle for a series of constant sample volumes.

In the crystallization chip 100 described herein, the discrete hydrophilic 106 areas keep the crystallization drop in the same position by the force of surface tension. This helps to avoid accidental mixing of different crystallization drops when using the crystallization chip in a “hanging drop” method, e.g. when turning or flipping over the crystallization chip after adding the samples to the surface. The surface structuring admits exact positioning of the sample droplets.

Even if protein solutions contain detergents, the modification of surface wetting properties can efficiently avoid the uncontrolled dispersion of the solution on the crystallization chip surface.

The crystallization chip 100 can be used for crystal formation of any molecules, including proteins, chemical compounds, peptides, and other biological and non-biological molecules. In an example embodiment, the molecule is a biological macromolecule. In another example embodiment, the molecule is a small molecule.

Various reagents or crystallizing solutions can be pre-placed or dried on the surface of the crystallization chip, including various reagents to test different crystallization conditions. Such reagents are known to persons skilled in the art and can be found for example in the Hampton Research Catalog. A solution containing the molecule to be crystallized can then be added to the surface of the crystallization chip 100. Solutions on the crystallization chip 100 can be mixed by mechanical vibrations or by sending acoustic waves into the samples from the backside of the substrate using acoustic waves (for example, see U.S. Pat. No. 6,777,245).

It should also be noted that the crystallization chips described herein may reusable, or may be single use.

The crystallization chips disclosed herein can be used in sitting drop, hanging drop, and microbatch crystallization experiments.

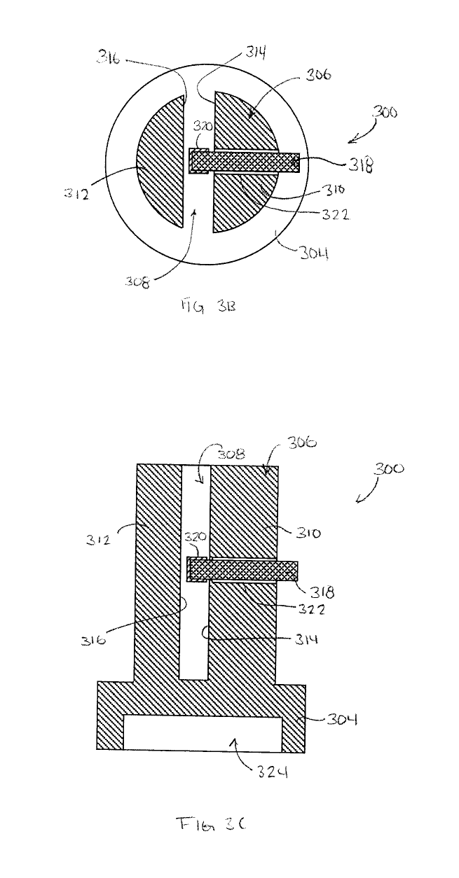

Referring now to FIGS. 3A-3E, an example embodiment of a crystallization chip mount 300 and a crystallization chip holder 302 are shown.

The crystallization chip mount 300 can be used to position the crystallization chip 100 described herein in any desired manner for a variety of purposes. The crystallization chip holder 300 can be used to receive and support the crystallization chip 100 described herein prior to, during and after the crystal growth process. The crystal growth process can take several days.

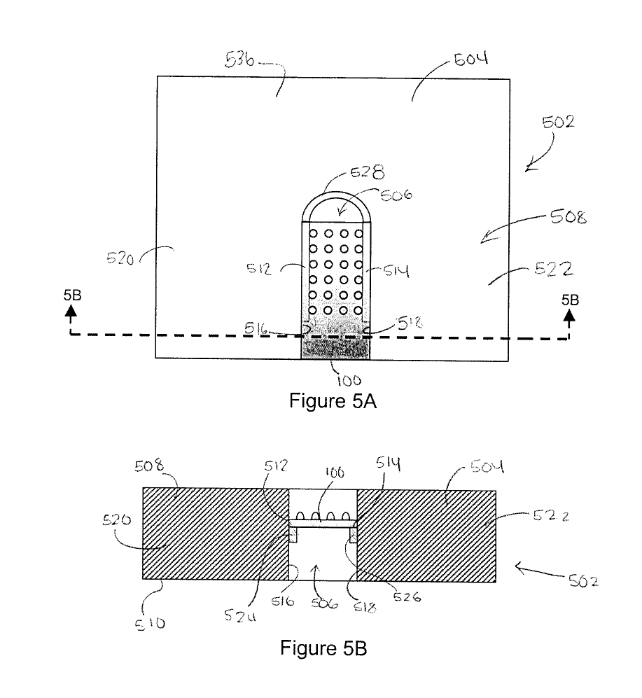

The crystallization chip mount 300 has a base 304 and a support structure 306 connected to the base 304. The support structure 306 is arranged to provide a channel or gap 308 to receive a portion of the crystallization chip 100 and maintain the crystallization chip 100 in a desired orientation. Once the crystallization chip 100 is inserted into the crystallization chip mount 300, the crystallization chip mount 300 can be used to easily position and inspect the crystallization chip 100 from a variety of different angles without compromising the integrity of the crystals that have just been grown. For example, the crystallization chip mount 300 can be used to position the crystallization chip 100 within an X-Ray diffractometer for analysis using the method of X-ray diffraction. This is described further below with regards to FIGS. 6 to 8.

In the example embodiment shown in FIGS. 3A-3C, the support structure 306 comprises first 310 and second 312 support members that are connected to the base 304. The first 310 and second 312 support members have flat surfaces 314,316 that are spaced apart from one another to define the channel or gap 308. In this example, the first 310 and second 312 support members are portions of a cylindrical body that are fixed to the base 304. One of the support members 310 is larger than the other 312 such that when the crystallization chip 100 is mounted onto the crystallization chip mount 300 and the crystallization chip 100 placed within the working site of the X-ray diffractometer, the surface of the crystallization chip with the grown crystals is aligned with the spindle of the X-ray diffractometer. Accordingly, the channel 308 is not symmetrically located in the support structure 306 but rather offset to one side. Furthermore, in an alternative embodiment one of the support members may be moveably connected to the base 304 so that during use it can be moved to reduce the size of the channel 308 to tightly hold the crystallization chip 100 in place. As shown in FIGS. 3A-3E, the channel 308 is vertical, however in other embodiments the channel 308 can be oriented at an angle other than 90 degrees with respect to base.

The support structure 306 further includes a biasing member 318 with a resilient portion 320 that is located within the channel 308 to hold the crystallization chip 100 in place in the channel 308. In this example embodiment, the biasing member 318 is a fastener 318 with a resilient portion 320, and one of the support members 310 includes a second channel 322 for releasably receiving the fastener 318. In use, the crystallization chip 100 is inserted into the first channel 308 and the fastener 318 is inserted through the second channel 322 such that the resilient portion 320 faces into the channel 322 to hold the crystallization chip 100 in place. The resilient portion 320 is used so that the crystallization chip 100 does not become damaged when being secured to the crystallization chip mount 300.

In this example embodiment, the biasing member 318 is a screw, the resilient portion 320 is a rubber tip and the second channel 322 comprises threads (not shown) that are configured to releasably receive the screw. The head of the screw can have an aperture that is shaped to receive the working end of an Allen key that can be used to tighten and loosen the screw.

However, in other embodiments other biasing members 318 can be used such as a spring-loaded pin with a rubber tip that has a vertically angled face, such as at 45 degrees, for example, so that when the crystallization chip 100 is inserted onto the crystallization chip mount 300, the lower edge of the crystallization chip 100 pushes down on the angled face of the pin such that the pin moves away from the vertical edge of the crystallization chip 100 and into the second channel 322 within one of the support members (not shown). However, since the pin is spring-loaded, the pin will apply pressure to the side of the crystallization chip to keep it in place.

In other alternative embodiments, another resilient material other than rubber can be used as is known by those skilled in the art so that the crystallization chip 100 is not damaged during insertion or removal from the crystallization chip mount 300.

In other embodiments, the resilient member 320 can be a soft pliable material that is placed on both flat surfaces 314, 316 of the support members 310, 312 such that the channel 308 has a width that is slightly smaller than the thickness of the crystallization chip 100. Accordingly, during insertion of the crystallization chip 100 onto the crystallization chip mount 300, the lower portion of the vertical edges of the crystallization chip 100 push the pliable material towards the flat surfaces 34, 316 of the support members. However, the pliable material has a sufficient material strength such that a compressive force is applied to the crystallization chip 100 to hold it in place.

In an example implementation, the first 310 and second 312 support members can be arranged such that the perimeter of the cylindrical shape formed by these two elements has a diameter of about 10 mm. The diameter of the base 304 is about 12 mm. The height of the base 304 is about 4 mm, the height of the support members 310, 312 is about 5 mm and the overall height of the crystallization chip mount 300 is about 9 mm. In this example, the base 304 has an inner circular bore 324 with a diameter of about 10 mm. The inner circular bore 324 can be dimensioned to fit on the goniometric head of an X-ray Diffractometer to increase the stability of the attachment of the chip mount 300 to the goniometric head during diffraction testing. However, there can also be embodiments in which the base 304 is solid.

In this example embodiment, the crystallization chip mount 300 is shown as a unitary element made from a single piece of material. However, in other embodiments, the crystallization chip mount 300 can be made from discrete elements that, where needed, are attached to one another using methods known to those skilled in the art.

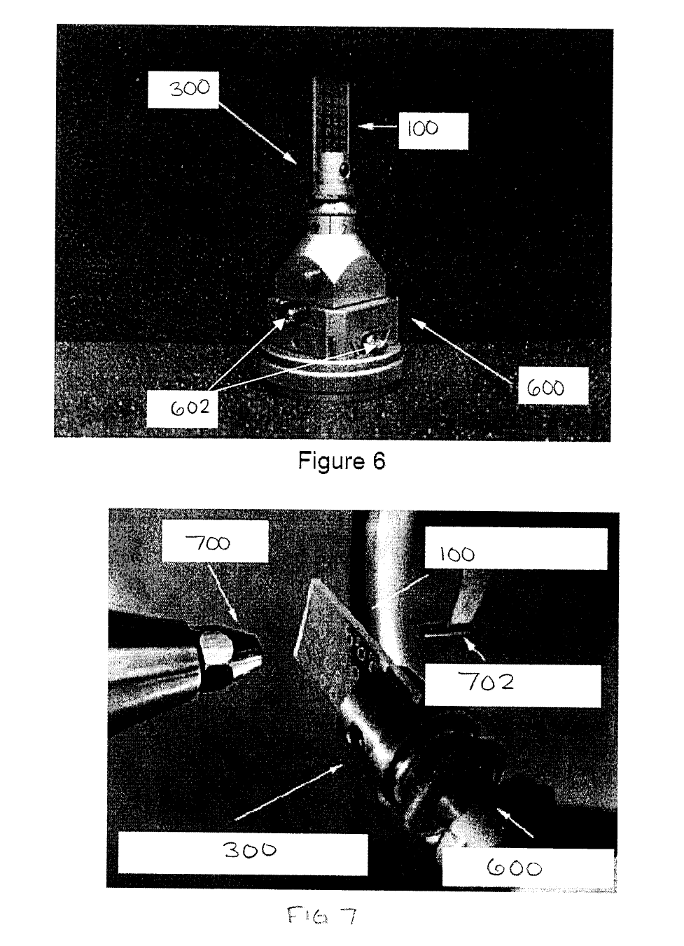

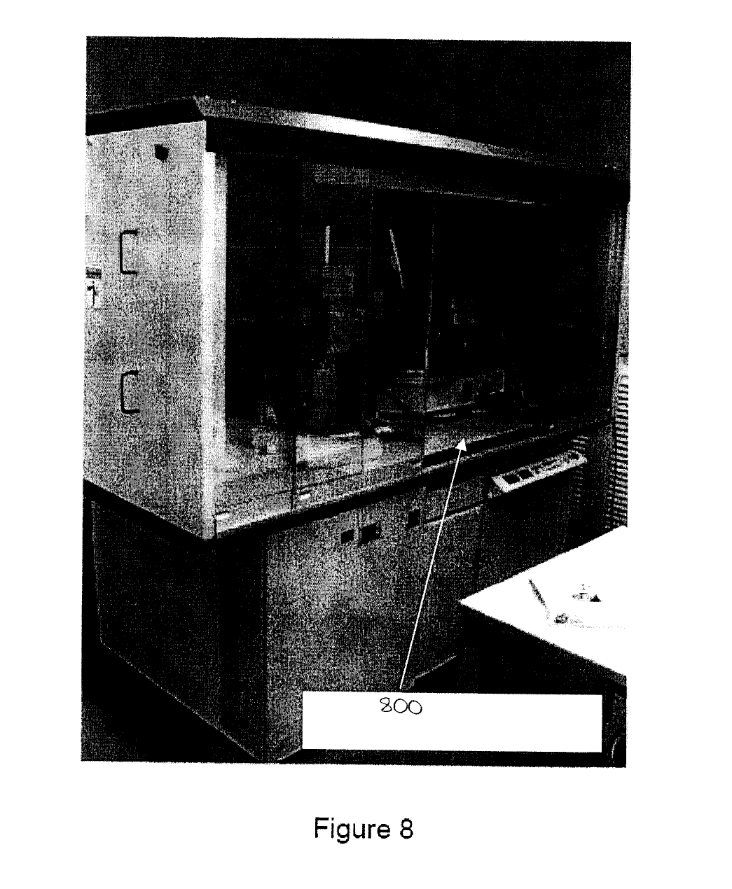

The crystallization chip mount 300 is arranged to have a geometry and size such that it can fit within a working site of a diffractometer. Accordingly, no modifications need to be made to the diffractometer during the analysis of a crystallization chip 100. In this regard, the base 304 of the crystallization chip mount 300 is made from a magnetic material, such as stainless steel for example, so that it can be easily releasably, but securably, mounted to the magnetic portion of a goniometric head 600 of the diffractometer, as shown in FIG. 6, using the magnetic force of attraction. The remaining portions of the crystallization chip mount 300 can be made from metallic materials or other suitable materials. Furthermore, the channel 308 of the crystallization chip mount 300 is oriented such that the surface of the crystallization chip is positioned so that the crystallization drops are positioned right on the spindle axes of the diffractometer as shown in FIG. 7, wherein an X-ray beam collimator is shown as numeral 700, and an x-ray beam stop is shown as numeral 702. This structure of the crystallization chip mount minimizes the number of manipulations to the chip that are needed to align individual crystallization drops for the analysis by X-ray diffraction. For instance, referring to FIG. 6, the screws 602 on the sides of the goniometric head 600 can be used to move different areas of the crystallization chip 100 into the beam of the X-ray diffractometer. An X-ray diffractometer 800 is shown in FIG. 8.

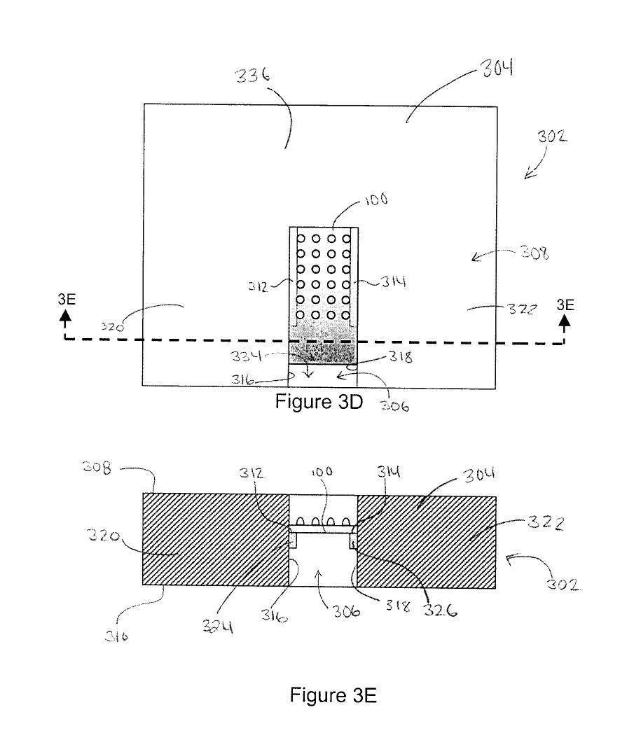

Referring now to FIGS. 3A, 3D, 3E and 4, shown therein are example embodiments of the crystallization chip holder 302. FIG. 4 additionally shows an alternate embodiment of a crystallization chip holder 402. The crystallization chip holder 302 supports one or more crystallization chips 100 in a generally horizontal position for short-term or long-term storage. The crystallization chip holder 302 can also be used to easily manipulate a crystallization chip 100 at various stages of the crystal growth process to facilitate visual inspection of the crystal drops over a period of time. The crystallization chip holder 302 can also be used to easily allow for the handling of the crystallization chip 100 prior to insertion onto the crystallization chip mount 300 for various applications such as inspection using an analysis device such as an X-ray diffractometer as explained above.

The crystallization chip holder 302 has a body 304 that defines at least one slot 306 to slidably receive the crystallization chip 100 described herein. The at least one slot 306 extends from an upper surface 308 to a lower surface 310 of the body. The crystallization chip holder 302 also includes at least one support surface for each slot. In the example shown in FIGS. 3D and 3E, the crystallization chip holder 302 includes two support surfaces 312, 314. For a given slot 306, the support surface(s) is/are disposed on at least two surfaces 316, 318 of portions 320, 322 of the body that define the given slot. During use, the at least one support surface supports the crystallization chip 100 prior to, during or after the formation of crystals.

The embodiments 302 shown in FIGS. 3A, 3D, 3E are examples of crystallization chip holders that can hold one crystallization chip. The additional embodiment 402 shown in FIG. 4 can hold four crystallization chips. These embodiments can be altered to hold another desired number of crystallization chips. For instance, there may be embodiments in which the slots that receive the crystallization chips are placed “back-to-back” so that two slots are collinear with respect to one another rather than being located in the side-by-side fashion shown in FIG. 4. This can be seen by placing two of the same type of crystallization chip holders shown in FIGS. 3A and 4 back to back. In this back-to-back configuration, there can also be another alternative embodiment in which the slots on either side of the crystallization chip holder are staggered with respect to one another. In other embodiments, the crystallization chip holder 302 can be shaped as a circle with the slots oriented along radial lines emanating from the centre of the circle and spaced apart from one another in the circumferential direction.

The support surfaces 312, 314 are arranged to support the crystallization chip 100 in a substantially horizontal manner during use. The support surfaces are defined by ribs 324, 326 along at least a portion of surfaces 316, 318 of at least two portions 320, 322 of the body of the crystallization chip holder 302 that forms a given slot 306. For instance, in some embodiments, first 324 and second 326 ribs can be positioned opposite one another on opposing surfaces of two adjacent extension portions 320, 322 of the body that define the slot. In other embodiments, a third rib (not shown) can also be provided at the same height as the first and second ribs and disposed on a third surface of the slot. In other embodiments, the two ribs can be used on surfaces that are not directly opposite one another.

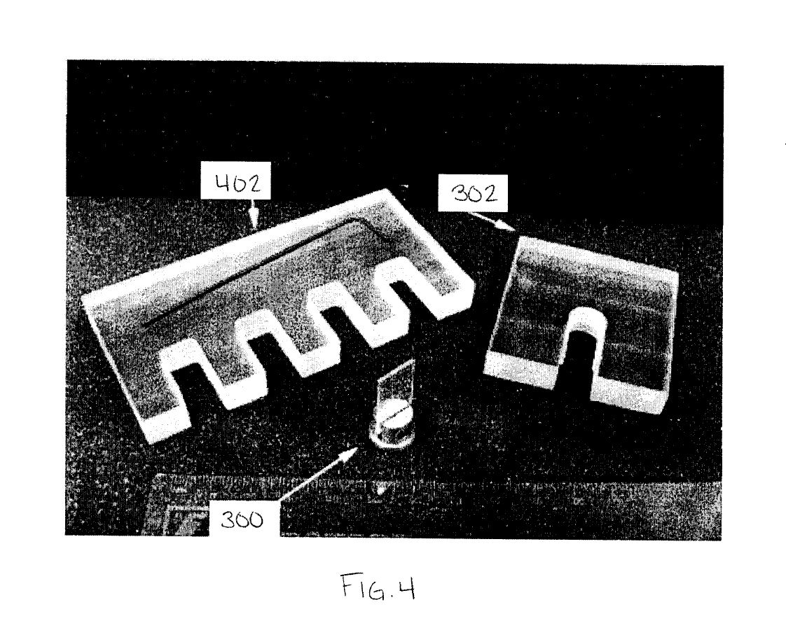

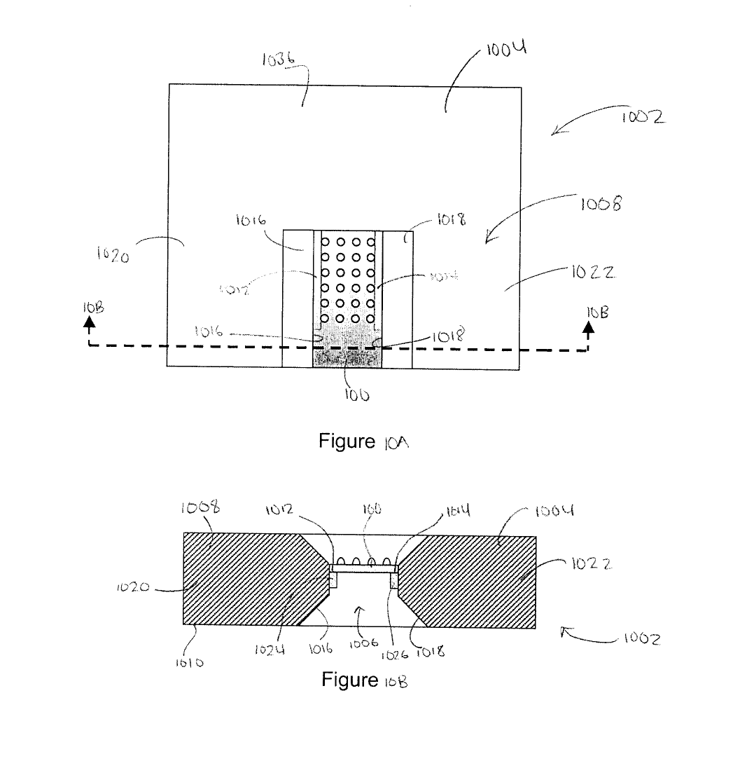

In alternative embodiments, other elements can be used for the support surface. For example, in some embodiments, the support surface is a ledge formed along surfaces of the portions of the body that define the given slot. In other examples, as shown in FIGS. 5A and 5B, wherein like numerals are used to refer to like elements shown in FIGS. 3D and 3E, with the first digit incremented from 3 to 5, if the slot has an arch shape, the surfaces 512, 514 are joined by an arch portion 528 such as in the exemplary embodiment shown in FIGS. 5A and 5B. In addition, in other embodiments, the surfaces of the body of the crystallization chip holder that defines the slots can be sloped as shown in FIGS. 10A and 10B, wherein like numerals are used to refer to like elements shown in FIGS. 3D and 3E, with the first digit incremented from 3 to 10. This makes is easier to insert and remove the crystallization chips from the crystallization chip holder.

In alternative embodiments (not shown), the crystallization chip holder has multiple support surfaces configured to hold multiple crystallization chips 100 spaced apart from one another in a stacked manner. For instance, the multiple support surfaces can be several sets of ribs (one set of ribs is described above) and each set of ribs is at different height to store several crystallization chips in a stacked fashion with sufficient spacing such that the crystallization chips do not touch or otherwise interfere with one another.

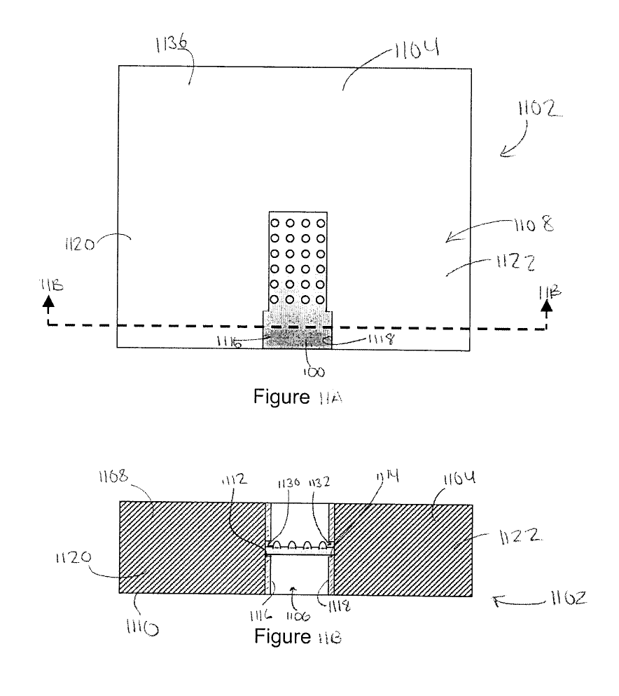

In another alternative embodiment, shown in FIGS. 11A and 11B, wherein like numerals are used to refer to like elements shown in FIGS. 3D and 3E, with the first digit incremented from 3 to 11, rather than using ribs, grooves or channels 1130, 1132 can be formed into the faces of the protruding portions 1120, 1122, so that the edges of the crystallization chip 100 can slide into the grooves 1130 as the crystallization chip 100 is inserted into the crystallization chip holder 1102. However, in this case, the crystallization chip 100 and the grooves 1130, 1132 are dimensioned such that crystals near the edges of the crystallization chip 100 are not damaged when inserting or removing the crystallization chip from the crystallization chip holder 1102.

As shown in FIGS. 3A, 3D, 3E, 4 and 5A-5F a slot 306, 506 can have a rectangular shape or an arch shape. Also, the slots 506 have a depth such that no portion of the crystallization chip 100 extends past the face of the holder 502 when the placed within a holder 502 as shown in FIG. 5A. In other words, the slots 306, 506 have a depth at least as large as the length of the crystallization chip 100. This prevents the crystallization chip 100 from being accidentally moved since it totally fits within a slot 306, 506. The slot 306 can also have a large depth to define an empty region 334 between the end of the chip and the front face of the chip holder when the chip 100 is pushed all the way into the slot. This empty region 334 allows one to position the crystallization chip holder to “pick-up” the crystallization chip when it is stored.

Also, in the example embodiments shown in FIGS. 3A, 3D, 3E, 4, 5A-5B, and 10A to 11B, the crystallization chip holder includes a solid handling portion 336 without any slots and adjacent to the extension portions 320, 322. The handling portion 336 can be used to carry or otherwise physically manipulate the crystallization chip holder 302 without compromising the integrity of the crystallization chips 100. The handling portion 336 can also be used to receive an identifier such as a bar code for a variety of purposes such as identifying the experiments that are being conducted on the crystallization chips 100 that are being held by the crystallization chip holder 302.

In some embodiments, the handling portion 336, extension portions 320, 322 and the support surfaces 312, 314 can be made as separate pieces and then connected together as is known by those skilled in the art. Alternatively, the handling portion 336, the extension portions 320, 322 and the support surfaces 312, 314 can be formed as an integral piece.

In an example implementation, the crystallization chip holder 302 shown in FIGS. 3A, 3D and 3E has a length of about 50 mm, a width of about 50 mm, and a height of about 7 mm. The slot 306 has a width of about 10 mm, and the side ribs 324, 326 have a thickness of about 2 mm. An optional third rib (not shown), extending between the side ribs, may have a thickness of about 1 mm. The ribs 324, 326 have a height of about 5 mm and are located about 2 mm from the top 308 and bottom 310 of the crystallization chip holder 302. Generally, the dimensions of the slot 306 and the ribs 324, 326 are selected such that the crystallization chip 100 can easily slide into and out of the slots 306.

The crystallization chip holder 302 can be made from any material that will not compromise the crystal growth process. Materials can be used that are easy to work with. Plexi-glass or plastic materials may be used for instance. Transparent materials can also be used if desired.

While a crystal drop is much too small and volatile to directly manipulate for analysis, the crystallization chip holder 302 can be used to easily work crystal drops. For instance, since the slot 306 extends from the top surface 308 of the crystallization chip holder to the bottom surface 310, the handling portion 336 of the crystallization chip holder 302 can be used to easily transfer and place a crystallization chip 100 under a microscope without removing the crystallization chip 100 from the crystallization chip holder 302. This is possible since the slot 306 does not have any material blocking the polarized light from the microscope during analysis. Accordingly, there is just air or otherwise empty space underneath the crystallization chip 100 while it is in the crystallization chip holder 302 so that the measurements that are made with the polarizing microscope are not compromised.

An additional aspect of the application is a kit comprising the crystallization chip 100, crystallization chip mount 300 and/or crystallization chip holder 302. The kit allows for crystallization experiments by placing crystal drops onto the crystallization chip 100, placing the crystallization chip into the crystallization chip holder 302 and then eventually moving the crystallization chip 100 to the crystallization chip mount 300 so that it can be analyzed with an X-ray diffractometer. Ideally, the crystallization chip 100 is handled once when it is placed with the crystallization chip holder 302. After that the slots 306 of the crystallization chip holder are designed such that the crystallization chip mount 300 can be easily positioned to pick up the crystallization chip 100 without a user directly handling the chip 100 with their hands. Accordingly, the crystallization chip 100, crystallization chip holder 302 and crystallization chip mount 300 allow the crystallization experiments to be automated due to the robustness and functionality of each of these elements.

Another aspect of the application is a method for high-throughput microbatch crystallization using the crystallization chip 100 disclosed herein. Accordingly, one aspect of the invention is a method for crystallizing a molecule, comprising the steps:

(a) providing the crystallization chip 100 described herein;

(b) growing at least one crystal of a molecule on said crystallization chip 100.

The invention also includes methods for analyzing crystals of the molecule in situ. Accordingly, another aspect of the invention includes a method for analyzing a crystal of a molecule, comprising the steps:

(a) providing the crystallization chip 100 described herein;

(b) applying a solution of a selected molecule to at least one hydrophilic region of the crystallization chip 100;

(c) growing at least one crystal of said molecule; and

(d) using an X-ray diffractometer to analyze the crystal in situ.

In at least one example embodiment, a method of microbatch crystallization is used to grow the crystal.

Crystallization methods involve exploitation of the phase diagram to achieve supersaturation. Vapor diffusion methods are dynamic, self-screening processes whereby all components of the drop concentrate during equilibration with the reservoir solution. In the batch method, the volume of the drop does not change, supersaturation is achieved upon mixing of all the components at the start of the experiment, and no significant changes in the concentrations of the components occurs (except for the protein as it comes out of solution). The microbatch method is a form of the batch method which reduces the amount of sample needed by dispensing small volumes of the sample of interest and the crystallization reagent(s) under a thin layer of oil (usually paraffin).

The methods described above optionally include applying an oil solution to the hydrophobic region(s) of the crystallization chip to cover the solution of the selected molecule on the crystallization chip 100. In addition, the methods optionally include visualizing the surface of the crystallization chip 100 to determine the presence or absence of a crystal. For example, visualization can be done using a microscope.

The methods described above optionally include a crystallization chip 100 with pre-placed or dried reagents as described above. Thus, a solution of a selected molecule is applied to at least one hydrophilic region on the crystallization chip, then the solution is mixed with the pre-placed or dried reagents using a mixing device (e.g. acoustic waves, mechanical vibrations, and the like). Then, an oil solution is optionally applied to the hydrophobic regions of the crystallization chip 100. The crystal of the molecule is allowed to grow.

The crystallization chip 100 is optionally placed on the crystallization holder 302 at any step of the methods of the invention.

The crystal can be analyzed in situ using an X-ray diffractometer. The crystallization chip is optionally inserted into the crystallization mount 300 to facilitate the X-ray diffraction analysis.

The above disclosure generally describes the present invention. A more complete understanding can be obtained by reference to the following specific examples. These examples are described solely for the purpose of illustration and are not intended to limit the scope of the invention. Changes in form and substitution of equivalents are contemplated as circumstances might suggest or render expedient. Although specific terms have been employed herein, such terms are intended in a descriptive sense and not for purposes of limitation.

The following non-limiting examples are illustrative of the present invention:

### EXAMPLES

Optimization of the crystallization conditions is a tedious and time-consuming process. Having reliable information obtained in a high-throughput fashion at this decision making stage can drastically expedite and can have a substantial impact on the whole process of structure determination. The inventors provide materials and methods which can be used for high-throughput crystallization assays.

Table 1 shows the results of various hydrophilic dimensions and hydrophobic dimensions on the surface of the slide, and the dimensions and volumes of the protein solution and oil layer used.

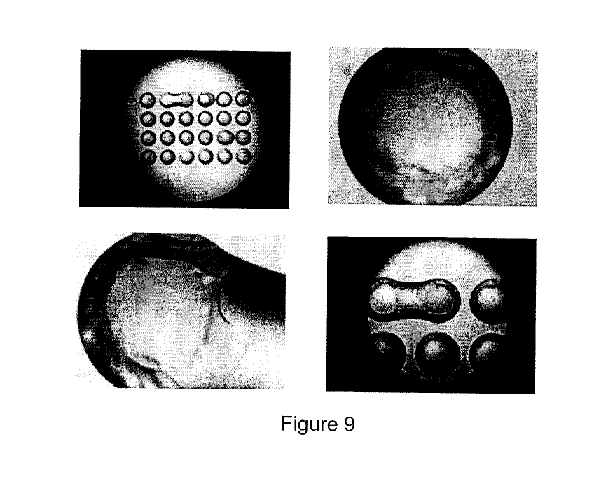

FIG. 9 is a series of photographs showing crystals formed using the crystallization chip and methods described herein. The crystallized material shown in this example is the protein SA0606 from Staphylococcus aureus. In the example shown, the protein sample was screened for crystals using a portion of the commercially available crystallization screen PACT from Qiagen (Newman, J. et al. (2005), “Towards rationalization of crystallization screening for small- to medium-sized academic laboratories: the PACT/JCG+ strategy”, Acta. Cryst. D61, 1426). Each drop consists of 0.25 μl of protein solution plus 0.25 μl of precipitant solution overlaid with 1 μl of paraffin oil. As shown in the photographs, crystals were observed in a number of the crystallization conditions.

While the present invention has been described with reference to what are presently considered to be the preferred examples, it is to be understood that the invention is not limited to the disclosed examples. To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

TABLE 1

| D_protein | V_protein | H_oil | H_total | alpha | D_oil | V_oil | Ratio |
|---|---|---|---|---|---|---|---|
| (μm) | (μl) | (μm) | (μm) | (°) | (μm) | (μl) | V_oil/V_protein |
| 1240 | 0.499 | 50 | 670 | 65 | 2103.38 | 1.39 | 2.79 |
| 1240 | 0.499 | 100 | 720 | 65 | 2260.35 | 1.84 | 3.70 |
| 1240 | 0.499 | 150 | 770 | 65 | 2417.32 | 2.37 | 4.75 |
| 1240 | 0.499 | 300 | 920 | 65 | 2888.22 | 4.39 | 8.80 |
| 1560 | 0.993 | 50 | 830 | 65 | 2605.68 | 2.60 | 2.61 |
| 1560 | 0.993 | 100 | 880 | 65 | 2762.65 | 3.29 | 3.31 |
| 1560 | 0.993 | 200 | 980 | 65 | 3076.58 | 4.92 | 4.95 |
| 1560 | 0.993 | 300 | 1080 | 65 | 3390.52 | 6.92 | 6.96 |

1. A crystallization chip comprising a substrate that has a planar surface and that has one or more hydrophilic regions on said planar surface, wherein each of the hydrophilic regions is bordered by a hydrophobic region.

2. The crystallization chip according to claim 1, wherein the substrate is a transparent material or a combination of transparent materials.

3. The crystallization chip according to claim 2, wherein the transparent material is glass, quartz, silicone, poly(dimethyl-siloxane), or plastic.

4. The crystallization chip according to claim 1, wherein the substrate is rectangular and has the dimensions of approximately 10 to 20 mm in length, 5 to 10 mm in width and a height selected to minimize absorption of X-rays.

5. The crystallization chip according to claim 1, wherein the height is 0.1 to 1 mm.

6. The crystallization chip according to claim 1, wherein the crystallization chip has 1 to 5000 hydrophilic regions.

7. The crystallization chip according to claim 1, wherein the hydrophilic regions are circular, triangular or hexagonal.

8. The crystallization chip according to claim 1, wherein each of the hydrophilic regions holds a volume of liquid from about 1 nl to 50 μl.

9. The crystallization chip according to claim 1, wherein the hydrophobic regions are bordered by a hydrophilic region.

10. A combination comprising:
a crystallization chip including a substrate that has a planar surface and that has one or more hydrophilic regions on said planar surface, wherein each of the hydrophilic regions is bordered by a hydrophobic region; and
a crystallization chip mount including:
a base, and
a support structure connected to the base, the support structure being arranged to provide a first channel to receive a portion of the crystallization chip.

11. The combination of claim 10, wherein the support structure comprises first and second support members connected to the base, the first and second support members having flat surfaces spaced apart from one another to define the first channel.

12. The combination of claim 11, wherein the support structure further comprises a biasing member with a resilient portion located within the first channel and configured to hold the crystallization chip in place in the first channel.

13. The combination of claim 12, wherein the biasing member is a fastener with a resilient portion, and one of the first and second support members comprises a second channel for releasably receiving the fastener, wherein in use the crystallization chip is inserted into the first channel and the fastener is inserted through the support member comprising the second channel with the resilient portion facing into the first channel to abut a surface of the crystallization chip.

14. The combination of claim 13, wherein the biasing member is a screw, the resilient portion is a rubber tip and the second channel comprises threads configured to releasably receive the screw.

15. The combination of claim 10, wherein the crystallization chip mount is arranged to have a geometry and size that can fit within a working site of an X-ray diffractometer.

16. The combination of claim 15, wherein the first channel is offset to one side of the support structure to align the surface of the crystallization chip having the hydrophilic and hydrophobic regions with a spindle axis of the X-ray diffractometer during analysis.

17. The combination of claim 16, wherein the base is made of a magnetic material to releasably attach to a magnetic portion of a goniometric head of the X-ray diffractometer.

18. A combination comprising:
a crystallization chip including a substrate that has a planar surface and that has one or more hydrophilic regions on said planar surface, wherein each of the hydrophilic regions is bordered by a hydrophobic region; and
a crystallization chip holder including:
a body defining at least one slot to slidably receive the crystallization chip, the at least one slot extending from an upper surface to a lower surface of the body, and
at least one support surface for each slot, wherein for a given slot the at least one support surface is disposed on an edge of at least two surfaces of portions of the body that define the given slot, wherein, during use, the at least one support surface supports the crystallization chip prior to, during or after the formation of crystals.

19. The combination of claim 18, wherein the at least one support surface comprises first and second ribs on surfaces of two portions of the body that define the given slot.

20. The combination of claim 19, wherein the at least one support surface further comprises a third rib at the same height as the first and second ribs and disposed on a third surface of a portion of the body that defines the given slot.

21. The combination of claim 18, wherein the at least one support surface comprises a ledge formed along surfaces of the portions of the body that define the given slot.

22. The combination of claim 18, wherein the crystallization chip holder comprises multiple support surfaces configured to hold multiple crystallization chips spaced apart from one another in a stacked manner.

23. The combination of claim 18, wherein the at least one slot to has a depth larger than the length of the crystallization chip.

24. The combination of claim 18, wherein surfaces of the body that define the slot are sloped.

25. The combination of claim 18, wherein the crystallization chip holder comprises a handling portion to allow a user to physically manipulate the crystallization hip holder and to receive an identifier.

26. The combination of claim 18, wherein the crystallization chip holder further comprises extension portions, wherein a pair of the extension portions defines the at least one slot.

27-39. (canceled)
